(19) United States
(12) Patent Application Publication
(10) Pub. No.: US 2011/0037299 A1
(43) Pub. Date: Feb. 17, 2011

(54) CLIMBING ATTACHMENT FOR A CHILD SEAT

(76) Inventor: DENNIS KIRKPATRICK, Auburn, NE (US)

Correspondence Address: LAW OFFICE OF JERRY D. HAYNES , P.A, P.O. Box 350392, Fort Lauderdale, FL, 33335, US

(21) Appl. No.: 12/541,150

(22) Filed: Aug. 13, 2009

(51) Int. Cl. B60N 2/26; A47C 7/62; B60N 2/44

(52) U.S. Cl. 297/217.1

(57) ABSTRACT

The present invention relates to a climbing attachment for a child's car seat comprising: a padding portion, where said padding portion is place under an existing child seat; a series of rungs, where said rungs hang from the padding portion; and a mechanism to attach said climbing attachment to a child's car seat. In one exemplary embodiment the mechanism to attach includes at least one anchor strap and preferably includes two anchor straps. The series of rungs may be evenly spaced. The present invention also contemplates a method of assembling a climbing attachment for a child's seat comprising the steps of: attaching a series of rungs to a padding portion, where said rungs hang vertically from the padding portion; inserting the padding portion under a child's car seat; and securely attaching the climbing attachment to the child's car seat.

### BACKGROUND OF THE INVENTION

1. Field of Invention

The present invention relates to a climbing attachment that is utilized with a child's car seat.

2. Description of Related Art

A child's car seat is a restraining device used in an automobile in order to safely seat and harness an infant while traveling in the automobile. Child seats are usually placed in the rear seat of an automobile and include straps and harnesses that secure the child within the seat during travel. Infant car seats are made to accommodate infants of sizes of 5 to 20 pounds and may fit children up to the height of 30 inches. Smaller infants usually use a rear-facing seat for safety reasons. Larger infants may use a front-facing car seat that may allow for the insertion of an attachment that could assist the child in entering and exiting the seat. Many times children may desire to climb into the seat with their own power; however, many of the front-facing car seats do not have a means to assist an infant in entering the car seat.

Larger infants, or infants that may be a year or more who have achieved a level of mobility and are able to walk and climb may desire to climb into the car seat under their own power with the supervision of an adult. Car seats available in the prior art typically do not provide any means to assist an infant in climbing into the seat, or a means to allow the child to exit from the seat.

### SUMMARY OF THE INVENTION

The present invention relates to a climbing attachment for a child's car seat comprising: a padding portion, where said padding portion is place under an existing child seat; a series of rungs, where said rungs hang from the padding portion; and a means to attach said climbing attachment to a child's car seat. In one exemplary embodiment the means to attach includes at least one anchor strap and preferably includes two anchor straps. The series of rungs may be evenly spaced. The present invention also contemplates a method of assembling a climbing attachment for a child's seat comprising the steps of: attaching a series of rungs to a padding portion, where said rungs hang vertically from the padding portion; inserting the padding portion under a child's car seat; and securely attaching the climbing attachment to the child's car seat.

### BRIEF DESCRIPTION OF DRAWINGS

FIG. 1 depicts a climbing attachment according to the present invention.

FIG. 2 depicts the climbing attachment according to the present invention placed upon a child's car seat.

### DETAILED DESCRIPTION

The present invention provides a climbing attachment that may be placed under and attached to a child's car seat to provide a means for entering and exiting the car seat. The climbing attachment includes a series of rungs that are extended vertically off the front portion of the car seat. The climbing attachment may be placed under the car seat and secured to the car seat via anchor straps.

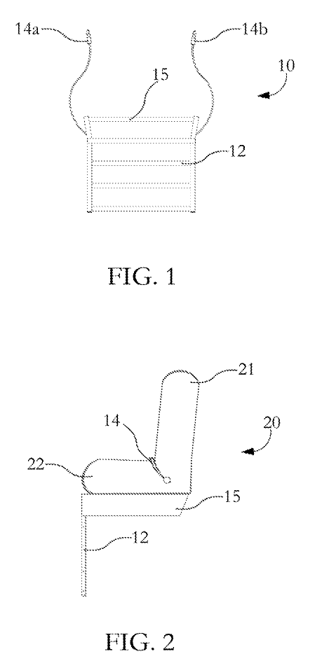

The climbing attachment according to the present invention is depicted in FIG. 1. The climbing attachment (10) includes a series of rungs (12) that extend vertically off a padding (15). The climbing attachment (10) further includes anchor straps (14a, 14b). This configuration of the climbing attachment (10) may be utilized in conjunction with a vehicle car seat.

In FIG. 2, the climbing attachment (10) is shown attached to a car seat (20). As depicted, the padding portion (15) inserts under the seat (22) of the car seat (20). Anchor straps (14a, 14b) secure the climbing attachment (10) to the car seat (20). The series of rungs (12) extend vertically off the front portion of the car seat and, therefore, provide a means for entering and exiting the car seat. In the preferred embodiment, the series of rungs are evenly spaced and in one particular embodiment may be spaced about three inches apart and extend ten inches in total length.

The climbing attachment (10) provides a climbing system for children to enter and exit the child car seat. The climbing attachment (10) is especially useful in high-sitting cabins that are usually found in SUVs and in some minivans. The climbing attachment (10) is also useful for parents/guardians who may be occupied and it allows the child to enter the car seat with minimum assistance from their guardian. Furthermore, infants of this age are known to be quite active and this climbing attachment provides yet another means to release their energy and exhibit their activity. The instant invention has been shown and described in what it considers to be the most practical and preferred embodiments. It is recognized, however, that departures may be made there from within the scope of the invention and that obvious modifications will occur to a person skilled in the art.

What is claimed is:

1. A climbing attachment for a child's car seat comprising:
a. a padding portion, where said padding portion is place under an existing child seat;
b. a series of rungs, where said rungs vertically hang from the padding portion; and
c. a means to attach said climbing attachment to a child's car seat.

2. The climbing attachment according to claim 1, where said means to attach includes at least one anchor strap.

3. The climbing attachment according to claim 1, where said means to attach includes two anchor straps.

4. The climbing attachment according to claim 1, where said rungs are evenly spaced.

5. The climbing attachment according to claim 4, where said rungs are spaced three inches apart.

6. A method of assembling a climbing attachment for a child's seat comprising the steps of:
a. attaching a series of rungs to a padding portion, where said rungs hang vertically from the padding portion;
b. inserting the padding portion under a child's car seat; and
c. securely attaching the climbing attachment to the child's car seat.
